(19) United States
(12) Patent Application Publication
(10) Pub. No.: US 2026/0359703 A1
(43) Pub. Date: Nov. 12, 2026

(54) System and method for generating dynamic network sandboxes utilizing quantum computing

(71) Applicant: Bank of America Corporation, Charlotte, NC (US)

(72) Inventors: Manu Kurian, Dallas, TX (US); Michael R. Young, Davidson, NC (US)

(21) Appl. No.: 19/200,166

(22) Filed: May 6, 2025

(51) Int. Cl. G06N 10/80; G06F 21/53; G06N 10/60

(52) U.S. Cl. CPC G06N 10/80; G06F 21/53; G06N 10/60

(57) ABSTRACT

A system includes a memory configured to store instances of a software application executable on a plurality of computing node devices comprising a quantum mesh network and a set of historical adversarial interactions. The system includes a quantum processor operably coupled to the memory and configured to determine an execution of adversarial user interactions. In response, the quantum processor is configured to execute an artificial-intelligence model to generate a dynamic network sandbox configured to restrict the execution of adversarial user interactions to only the dynamic network sandbox and to generatively present sequences of different decoy data to a user in response to the execution of adversarial user interactions. The quantum processor is configured to uniquely identify the user based on the generatively presented sequences of different decoy data and the execution of the adversarial user interactions and reject further requests from the uniquely identified user.

### TECHNICAL FIELD

The present disclosure relates generally to quantum computing, and, more specifically, to a system and method for generating dynamic network sandboxes utilizing quantum computing.

### BACKGROUND

Certain cloud-computing based environments may include data stored across any number of databases and associated with any number of entities. For example, the data may include various user data or service data that may be stored to databases associated with respective entities, and that user data or service data may be accessed by any number of centralized or decentralized servers for servicing applications associated with various users. However, such cloud-computing based environments may be sometimes subjected to various cyberthreats and cyberattacks.

### SUMMARY

The system and methods implemented by the system as disclosed in the present disclosure provide technical solutions to the technical problems discussed above by providing systems and methods for generating dynamic network sandboxes utilizing quantum computing. The disclosed system and methods provide several practical applications and technical advantages. Specifically, the present embodiments improve the adaptability, reliability, and security coverage of network sandboxes, as well as the computing systems and computing networks on which the network sandboxes may be executed.

A network sandbox may generally include an isolated computing environment suitable for analyzing, detecting, and isolating potential adversarial users or malicious code as the potential adversarial users traverse a computing network or execute malicious code. For example, existing network sandboxes may generally function by intercepting suspicious or unusual user interactions of potential adversarial users and isolating the potential adversarial users to what appears as a fully-functioning end-user computing environment. However, while existing network sandboxes may generally perform well in terms of detecting less sophisticated malicious code (e.g., unsophisticated malware) and isolating less sophisticated potential adversarial users (e.g., unsophisticated hackers and eavesdroppers), existing network sandboxes may often perform poorly in terms of detecting and isolating sophisticated cyberattackers and user interactions (e.g., executing scripts that obfuscate malicious content, performing a higher number of legitimate user tasks mixed in with performing only a few adversarial user tasks, and so forth) specifically designed and suited to evade the detection and entrapment of network sandboxes. That is, due to their largely static nature, existing network sandboxes may lack the requisite adaptability, reliability, and security coverage to protect computing systems and networks against the sophisticated tactics, techniques, and procedures (TTPs) of modern cyberattackers, eavesdroppers, and snoopers.

Accordingly, the present embodiments are directed to a combined classical computing and quantum computing system and mesh network suitable for generating and instantiating dynamic network sandboxes utilized to protect the quantum computing system and quantum mesh network against the advanced TTPs of cyberattackers, eavesdroppers, snoopers, or other similar adversarial users. As used herein, a “dynamic network sandbox” may refer to any artificial-intelligence (AI) model generated network sandbox suitable for detecting, identifying, isolating, and entrapping suspicious or unusual user interactions and/or malicious code in real-time or near real-time by generatively presenting sequences of different decoy data (e.g., decoy computing node devices, decoy databases, decoy applications, decoy services, decoy operating systems, decoy user-performable tasks, decoy business data, decoy user data, and so forth) to a potential adversarial user as the potential adversarial user executes user interactions and/or traverses through a computing network or computing system. Specifically, a “dynamic network sandbox” may be generated utilizing one or more AI models to accurately emulate the legitimate computing network or computing system and personalize the network sandbox to the potential adversarial user, such that as the potential adversarial user executes user interactions and/or traverses the “dynamic network sandbox,” the “dynamic network sandbox” tracks the user interactions and user activities and generatively presents sequences of different decoy data that are specifically responsive to the tracked user interactions and user activities.

For example, in accordance with the presently disclosed embodiments, in response to a determination that an execution of one or more user interactions corresponds one or more potential adversarial user interactions, the combined classical computing and quantum computing system may execute an artificial-intelligence (AI) model to generate a dynamic network sandbox suitable for restricting the execution of the one or more adversarial user interactions to only the dynamic network sandbox. In one embodiment, the dynamic network sandbox may be an emulation (e.g., a decoy emulation) of the “real” quantum mesh network. In another embodiment, the dynamic network sandbox may be a virtual quantum mesh network of virtual machines (VMs) (e.g., decoy VMs) of a number of computing node devices of the “real” quantum mesh network.

Specifically, in contrast to a static network sandbox, the dynamic network sandbox may learn and track the one or more adversarial user interactions and generatively present sequences of different decoy data (e.g., decoy computing node devices, decoy databases, decoy applications, decoy services, decoy operating systems, decoy user-performable tasks, decoy business data, decoy user data, and so forth) to the adversarial user that is responsive to the execution of the one or more adversarial user interactions so as to prompt and elicit the adversarial user to continue interacting within the dynamic network sandbox and with the different decoy data all while being isolated and restricted to the dynamic network sandbox. The combined classical computing and quantum computing system may then store a log of the generatively presented sequences of different decoy data, the adversarial user interactions, and a digital identity of the adversarial user. The combined classical computing and quantum computing system may then reject any future user interactions associated the adversarial user and/or any future user interactions from a computing device associated with the adversarial user.

Thus, the present embodiments may improve the adaptability, reliability, and security coverage of network sandboxes, as well as the computing systems and computing networks on which the network sandboxes may be generated and executed. Specifically, by utilizing one or more artificial-intelligence (AI) models to identify in real-time or near real-time potential adversarial user interactions and further to generate a dynamic network sandbox suitable for identifying, isolating, and entrapping the adversarial user interactions and/or the adversarial user by generatively presenting sequences of different decoy data responsive to those adversarial user interactions, the present embodiments may enable computing systems and computing networks to adapt their security posture in real-time or near real-time and protect against the advanced TTPs and novel attack vectors (e.g., zero-day attack vectors, zero-day exploits) of sophisticated cyberattackers, eavesdroppers, snoopers, and so forth. This thus leads to more adaptable, reliable, and secure computing systems and computing networks.

For example, for adversarial interactions that include executing scripts that obfuscate malicious content, the combined classical computing and quantum computing system may automatically detect a user attempting to perform either an unusual task or some tasks not performed before as the user attempting to exploit one or more novel attack vectors (e.g., zero-day attack vectors, zero-day exploits). The combined classical computing and quantum computing system may then generate the dynamic network sandbox and restrict execution of the scripts that obfuscate malicious content to the dynamic network sandbox. The dynamic network sandbox would then further generate different decoy data that lead the user to believe that the execution of the scripts was successful and allow the user to view decoy sensitive information and continue performing controlled tasks all while being isolated and entrapped in what appears to the user as a “real” (e.g., legitimate) computing system or computing network.

In this way, in addition to more adaptable, reliable, and secure computing systems and computing networks, the present embodiments also secure the underlying hardware computing devices of computing systems and computing networks, such as graphic processing units (GPUs), central processing units (CPUs), memory, routers, switches, and so forth, by isolating and entrapping adversarial user interactions and/or malicious code to the dynamic network sandbox (e.g., decoy emulation, quantum mesh network of decoy VMs). This ensures that none of the underlying hardware computing devices can be either compromised by the adversarial user interactions and/or malicious code or utilized as attack vectors to gain access or control of other components, applications, or services of the computing systems and computing networks.

Moreover, by utilizing the combined classical computing and quantum computing system and mesh network, the present embodiments may improve the efficiency and speed of generating dynamic network sandboxes and decoy data. Specifically, as N quantum bits (QuBits) may represent classical binary settings in 2^{N} simultaneously or in parallel, an N-QuBit quantum computing system may simultaneously explore 2^{N} possible solutions or perform 2^{N} simultaneous or parallel generations of the generatively presented sequences of different decoy data. Specifically, in classical computing systems alone, two classical bits may take only one of four states: 00 or 01 or 10 or 11. Each of the first bit and the second bit combines to represent only one binary configuration at a given time in a classical computing system alone, and thus represents a single binary configuration. However, one QuBit may exist in multiple states simultaneously. That is, the present combined classical computing and quantum computing system performs parallel processing to improve the efficiency and speed of generating dynamic network sandboxes and decoy data.

In this way, the combined classical computing and quantum computing system increases processing speed and reduces execution time as compared to any classical computing system alone because the combined classical computing and quantum computing system performs 2^{N} parallel operations to generatively present sequences of different decoy data to the adversarial user. Specifically, in accordance with the presently disclosed embodiments, the combined classical computing and quantum computing system may generate the dynamic network sandbox and sequences of different decoy data at a fast enough rate (e.g., in real-time) so as to prompt and elicit the adversarial user to continue interacting within the dynamic network sandbox and with the sequences of different decoy data. This allows the adversarial user's interactions to be tracked and recorded. That is, because the combined classical computing and quantum computing system increases processing speed with respect to generating the dynamic network sandbox and sequences of different decoy data, an adversarial user may be more likely to believe to be interacting within a “real” computing system or computing network as opposed to dynamic network sandbox, and thus may be prompted and elicited to continue interacting within the dynamic network sandbox and with the sequences of different decoy data.

The present embodiments are directed to systems and methods for generating dynamic network sandboxes utilizing quantum computing. In particular embodiments, a system includes a memory configured to store a plurality of instances of a software application executable on a plurality of computing node devices and a set of historical adversarial interactions. In one embodiment, the plurality of computing node devices may include a quantum mesh network of interconnected computing node devices. In particular embodiments, the system may further include a quantum processor operably coupled to the memory and configured to receive, from at least one instance of the software application executing on a computing node device associated with a user, a request to initiate an execution of one or more user interactions.

In particular embodiments, the quantum processor may be further configured to determine, based at least in part on the initiation of the execution of the one or more user interactions, that the execution of the one or more user interactions includes an execution of one or more adversarial user interactions. In particular embodiments, in response to the quantum processor determining that the execution of the one or more user interactions includes an execution of one or more adversarial user interactions, the quantum processor may then train an artificial-intelligence algorithm based at least in part on the quantum mesh network of interconnected computing node devices and the set of historical adversarial interactions to generate a dynamic network sandbox.

In particular embodiments, the quantum processor may be further configured to execute, based at least in part on the execution of the one or more adversarial user interactions, an artificial-intelligence model to generate a dynamic network sandbox comprising an emulation of the quantum mesh network of interconnected computing node devices configured to 1) restrict the execution of the one or more adversarial user interactions to only the dynamic network sandbox and to 2) generatively present sequences of different decoy data to the user in response to the execution of the one or more adversarial user interactions.

In particular embodiments, the quantum processor may be configured to execute the artificial-intelligence model to generate the dynamic network sandbox by generating a decoy quantum mesh network of interconnected computing node devices. In one embodiment, the decoy quantum mesh network of interconnected computing node devices may include an emulation of the quantum mesh network of interconnected computing node devices. In particular embodiments, the generatively presented sequences of different decoy data may include a plurality of user-performable tasks configured to elicit the user to complete the execution of the one or more adversarial user interactions while restricted to the dynamic network sandbox. In one embodiment, the quantum processor may be configured to associate with the plurality of user-performable tasks a set of access control rules. For example, in one embodiment, the set of access control rules comprises restrictive access permissions for the user when the user performs sensitive user-performable tasks and permissive access permissions for the user when the user performs non-sensitive user-performable tasks.

In particular embodiments, in response to determining at least a partial completion of the execution of the one or more adversarial user interactions while restricted to the dynamic network sandbox, the quantum processor may be further configured to uniquely identify the user based at least in part on the generatively presented sequences of different decoy data and the execution of the one or more adversarial user interactions. For example, in one embodiment, the quantum processor may be configured to store a log of the generatively presented sequences of different decoy data, the execution of the one or more adversarial user interactions, and a digital identity of the uniquely identified user. In particular embodiments, the quantum processor may be further configured to restrict further requests to initiate executions of the one or more user interactions from the uniquely identified user.

In particular embodiments, the quantum processor may be further configured to prompt the user to complete the execution of the one or more adversarial user interactions with the generatively presented sequences of different decoy data while restricted to the dynamic network sandbox. For example, in one embodiment, the generatively presented sequences of different decoy data may include a user-performable task. The quantum processor may be further configured to score the execution of the one or more adversarial user interactions as being one of a suspicious user interaction or a malicious user interaction, and further to determine whether to quarantine the user based at least in part on the score of the execution of the one or more adversarial user interactions.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a flowchart of an example method for generating dynamic network sandboxes utilizing quantum computing, in accordance with one or more embodiments of the present disclosure.

### DETAILED DESCRIPTION

### Example System

### System Overview

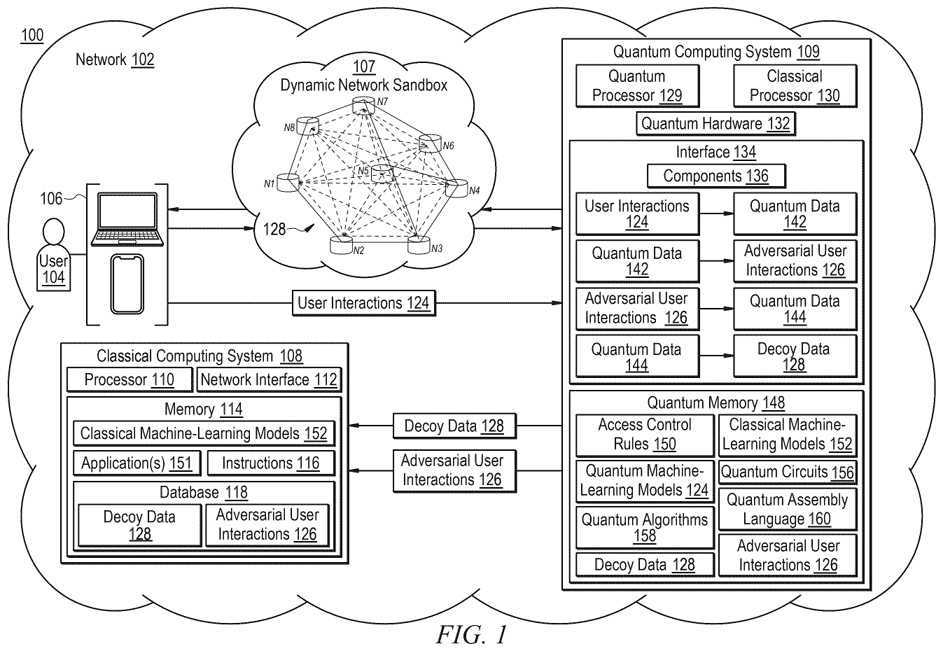

FIG. 1 is a block diagram of a combined classical computing and quantum computing system and quantum mesh network 100. As depicted, the combined classical computing and quantum computing system and quantum mesh network 100 may include one or more computing devices 106 that may be associated with a user 104, a classical computing system 108, a quantum computing system 109, a network 102 that enables the communications between the one or more computing devices 106, the classical computing system 108, and the quantum computing system 109, and a dynamic network sandbox 107. In particular embodiments, the classical computing system 108 and the quantum computing system 109 may be owned and managed by a single entity or organization, and thus, in some embodiments, the classical computing system 108 and the quantum computing system 109 may operate in conjunction and/or may be integrated to operate as a singular computing infrastructure.

In another embodiment, one of the classical computing system 108 and the quantum computing system 109 may be owned and managed by the single entity or organization while the other one of the classical computing system 108 and the quantum computing system 109 may be owned and managed by a third-party entity or organization and licensed to be utilized by the single entity or organization. In one embodiment, the classical computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

In general, the present embodiments relate a combined classical computing and quantum computing system and quantum mesh network 100 suitable for generating and instantiating dynamic network sandboxes 107 utilized to protect the classical computing system 108, the quantum computing system 109, and network 102 (e.g., quantum mesh network) against the advanced tactics, techniques, and procedures (TTPs) of cyberattackers, eavesdroppers, snoopers, or other similar adversarial users 104. As used herein, a “dynamic network sandbox” may refer to any artificial-intelligence (AI) model generated network sandbox (e.g., dynamic network sandbox 107) suitable for detecting, identifying, isolating, and entrapping suspicious or unusual user interactions (e.g., adversarial user interactions 126) and/or malicious code in real-time or near real-time by generatively presenting sequences of different decoy data 128 (e.g., decoy computing node devices, decoy databases, decoy applications, decoy services, decoy operating systems, decoy user-performable tasks, decoy business data, decoy user data, and so forth) to a user 104 (e.g., potential adversarial user 104) as the user 104 (e.g., potential adversarial user 104) executes adversarial user interactions 126 and/or traverses through the dynamic network sandbox 107 (e.g., a decoy emulation of a quantum mesh network 102).

In particular embodiments, the classical computing system 108 and/or the quantum computing system 109 may generate the dynamic network sandbox 107 utilizing one or more classical machine-learning (CML) models 152 and/or one or more quantum machine-learning (QML) models 154 to accurately emulate the network 102 and personalize the dynamic network sandbox 107 to the user 104 (e.g., potential adversarial user 104), such that as the user 104 (e.g., potential adversarial user 104) executes adversarial user interactions 126 and/or traverses the dynamic network sandbox 107, the dynamic network sandbox 107 tracks the adversarial user interactions 126 and generatively presents sequences of different decoy data 128 that are specifically responsive to the tracked adversarial user interactions 126.

For example, in accordance with the presently disclosed embodiments, in response to a determination that an execution of user interactions 124 corresponds to one or more adversarial user interactions 126, the classical computing system 108 and/or the quantum computing system 109 may execute one or more classical machine-learning (CML) models 152 and/or one or more quantum machine-learning (QML) models 154 to generate a dynamic network sandbox 107 suitable for restricting the execution of the adversarial user interactions 126 to only the dynamic network sandbox 107. In one embodiment, the dynamic network sandbox 107 may be a complete emulation (e.g., a decoy virtual representation) of the “real” network 102 (e.g., quantum mesh network). In another embodiment, the dynamic network sandbox 107 may be an emulation (e.g., a decoy virtual representation) of one or more specific computing node devices (e.g., “N1,” “N2,” “N3,” “N4,” “N5,” “N6,” “N7,” and “N8”) of the “real” network 102 (e.g., quantum mesh network).

Indeed, in particular embodiments, the dynamic network sandbox 107 may learn and track the adversarial user interactions 126 and generatively present sequences of different decoy data 128 (e.g., decoy computing node devices, decoy databases, decoy applications, decoy services, decoy operating systems, decoy user-performable tasks, decoy business data, decoy user data, and so forth) to the user 104 (e.g., potential adversarial user 104) that is responsive to the execution of the adversarial user interactions 126 so as to prompt and elicit the user 104 (e.g., potential adversarial user 104) to continue interacting within the dynamic network sandbox 107 and with the sequences of different decoy data 128 all while being isolated and restricted to the dynamic network sandbox 107.

In particular embodiments, the classical computing system 108 and/or the quantum computing system 109 may then store a log of the generatively presented sequences of different decoy data 128, the adversarial user interactions 126, and a digital identity of the user 104 (e.g., potential adversarial user 104). The classical computing system 108 and/or the quantum computing system 109 may then reject any future user interactions 124 associated with the user 104 (e.g., potential adversarial user 104) and/or any future user interactions 124 from a computing device 106 associated with the user 104 (e.g., potential adversarial user 104).

### Quantum Mesh Network

In some embodiments, the network 102 may be any suitable type of wireless and/or wired network. The network 102 may or may not be connected to the Internet or public network. For example, the network 102 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless radio frequency (RF) network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 102 may be configured to support any suitable type of communication protocol as would be appreciated by one of ordinary skill in the art.

In other embodiments, the network 102 may be a quantum mesh network 102. For example, in accordance with the presently disclosed embodiments, the network 102 may be a quantum network based on mesh topology (QNM) or other similar quantum mesh network 102 in which each computing node device (e.g., classical computing system 108, quantum computing system 109) is interconnected to each other computing node device (e.g., classical computing system 108, quantum computing system 109) in the quantum mesh network 102 via one or more of an optical fiber communication link (e.g., one or more fiber optic cables), a free-space optical communication link (e.g., photons of light emitted through free space), or a wireless RF communication link. For example, the quantum mesh network 102 may allow transmissions of QuBits or pairs of entangled QuBits to be distributed between spatially distant computing node devices (e.g., classical computing system 108, quantum computing system 109) even if one or more interconnections between a subset of computing node devices is interrupted.

In particular embodiments, although not illustrated, the quantum mesh network 102 may include any number of computing node devices, including both classical computing system(s) 108 and quantum computing system(s) 109 configured in respective one-to-one relationships. For example, in one embodiment, each classical computing system 108 may be interconnected to each other each classical computing system 108 and each other quantum computing system 109 via wireless RF communication links. In a similar manner, each quantum computing system 109 may be interconnected to each other each quantum computing system 109 via optical fiber communication links (e.g., one or more fiber optic cables) or free-space optical communication links (e.g., photons of light emitted through free space).

Thus, in such a network configuration, the quantum mesh network 102 may allow QuBits or pairs of entangled QuBits to be transferred between each quantum computing system 109 and each other each quantum computing system 109 via optical fiber or free-space optical communication links, and, by extension, allow QuBits or pairs of entangled QuBits to be transferred between each quantum computing system 109 and each classical computing system 108 by first converting the QuBits or pairs of entangled QuBits into classical bits of information and transferring those classical bits of information to the classical computing system(s) 108 via wireless RF communication links.

### Computing Device

The computing device 106 may generally be any device that may be utilized to process data and interact with a user 104. Examples of the computing device 106 include, but are not limited to, a personal computer, a desktop computer, a workstation, a server, a laptop, a tablet computer, a mobile phone (such as a smartphone), etc. The computing device 106 may include a user interface, such as a display, a microphone, keypad, or other appropriate terminal equipment usable by the user 104. The computing device 106 may include a hardware processor, memory, and/or circuitry (not explicitly shown) configured to perform any of the functions or actions of the computing device 106 described herein. For example, a software application designed using software code may be stored in the memory and executed by the processor to perform the functions of the computing device 106. The computing device 106 may be utilized to communicate with other components of the system and quantum mesh network 100 via the network 102.

In particular embodiments, the computing device 106 may be utilized by the user 104 to perform user interactions 124 with the quantum computing system 109 and/or the classical computing system 108. For example, in one embodiment, the computing device 106 may execute an instance of a software application 151 that may be hosted and executed by the classical computing system 108. In particular embodiments, the user 104 may access the instance of the software application 151 executing on the computing device 106 and perform user interactions 124 (e.g., one or more requests and/or replies), which may be transmitted over the network 102 between the computing device 106 and the quantum computing system 109 and/or the classical computing system 108.

### Classical Computing System

The classical computing system 108 may include any computing system that may be utilized to process data and communicate with other components of the system and quantum mesh network 100 via the network 102. In one embodiment, the classical computing system 108 may include a classical computing system suitable for executing binary or bitwise processing operations. As depicted, the classical computing system 108 may include a processor 110 in signal communication with a memory 114 and a network interface 112.

In particular embodiments, the processor 110 may include one or more processors operably coupled to the memory 114. The processor 110 may include any of various computing devices, such as a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various data and making one or more predictions or decisions based thereon, firmware (e.g., microcode), or some combination thereof.

The one or more processors 110 may be utilized to process data and may be implemented in hardware or software. For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

The network interface 112 may be utilized to enable wired and/or wireless communications (e.g., via network 102). The network interface 112 is configured to communicate data between the classical computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

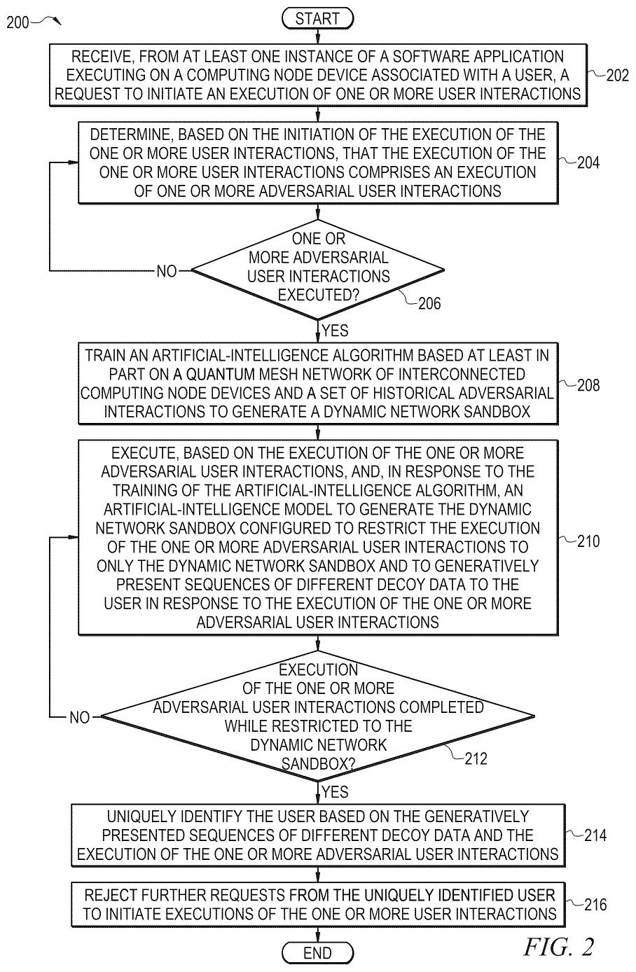

The memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1 and 2 along with any other data, instructions, logic, rules, or code operable to implement the function(s) described herein. The memory 114 is operable to store software instructions 116, and/or any other data and instructions.

The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted data structure. In one embodiment, the memory 114 may be understood to be a classical memory. In one embodiment, the memory 114 may include a non-transitory computer-readable medium. In particular embodiments, the database 118 may store adversarial user interactions 126 and decoy data 128, which may be identified by the quantum processor 129 utilizing one or more classical machine-learning (CML) models 152 and/or one or more quantum machine-learning (QML) models 154 in accordance with the presently disclosed embodiments.

### Quantum Computing System

The quantum computing system 109 may include any quantum computing system that may be utilized to process data and communicate with other components of the system 100 via the network 102. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with QuBits implemented by states of Josephson junctions), a trapped ion device (with qubits implemented by internal states of trapped ions), a trapped neutral atom device (with QuBits implemented by internal states of trapped neutral atoms), a photon-based device (with QuBits implemented by modes of photons), or any other suitable device that implements quantum bits with states of a respective quantum system.

In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the user interactions 124 and/or the adversarial user interactions 126.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, a vision transformer (ViT), a diffusion model, or other similar machine-learning model. In another embodiment, the one or more classical machine-learning (CML) models 152 may include one or more language models (LMs) or large language model (LLMs).

Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks. Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover's algorithm), quantum cryptography algorithms (e.g., Shor's algorithm, Deutsch-Jozsa Algorithm, Harrow-Hassidim-Lloyd (HHL) algorithm, Quantum Monte Carlo algorithm, and so forth), one or more quantum Fourier transform (QFT) based algorithms or inverse quantum Fourier transform (iQFT) based algorithms, one or more quantum particle swarm optimization (QPSO) algorithms, one or more quantum walks (QWs) algorithms, one or more classical quantum hybrid algorithms (e.g., Quantum Eigensolver), one or more classical quantum variational algorithms, one or more post-quantum cryptographic algorithms (e.g., quantum-resistant encryption algorithms), and/or other user-developed quantum algorithms that may be represented by instructions.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in particular embodiments, the interface 134 may convert user interactions 124 represented as classical binary bits of data into quantum data 142 for inputting into the one or more QML models 154, and, similarly, convert adversarial user interactions 126 represented as classical binary bits of data into quantum data 144 for inputting into the one or more QML models 154, for example.

In particular embodiments, the interface 134 may be further utilized to convert data items represented by quantum bits (QuBits) of data into classical binary bits of data. For example, in particular embodiments, upon the quantum computing system 109 extracting data from the user interactions 124 based on the quantum data 142, the interface 134 may convert the quantum data 142 representing the adversarial user interactions 126 into classical binary bits of data representing the adversarial user interactions 126. Likewise, upon the quantum computing system 109 generating decoy data 128 based on the quantum data 144, the interface 134 may convert the quantum data 144 representing the decoy data 128 into classical binary bits of data representing the decoy data 128.

In particular embodiments, the interface 134 may include a number of components 136 that may be utilized to generate and manipulate quantum bits (QuBits). In the illustrated embodiment, the number of components 136 and the quantum processor 129 are configured to operate on a same type of quantum bits (QuBits). For example, when the quantum processor 129 includes a photon-based device (with qubits implemented by modes of photons), the number of components 136 may include optical components such as lasers, mirrors, prisms, waveguides, interferometers, optical fibers, filters, polarizers, and/or lenses.

In particular embodiments, the quantum computing system 109 may utilize the one or more classical machine-learning (CML) models 152, the one or more quantum machine-learning (QML) models 154, or some combination thereof to generatively present sequences of different decoy data 128 to the user 104 (e.g., potential adversarial user 104) in response to an execution of one or more adversarial user interactions 126 with the different decoy data 128. For example, as will be discussed in greater detail below, the one or more classical machine-learning (CML) models 152, the one or more quantum machine-learning (QML) models 154, or some combination thereof may be utilized to generate a dynamic network sandbox 107 suitable for detecting, identifying, isolating, and entrapping suspicious or unusual user interactions (e.g., unusual user interactions 124) to the user 104 (e.g., potential adversarial user 104) as the user 104 (e.g., potential adversarial user 104) executes adversarial user interactions 126 and/or traverses through the dynamic network sandbox 107.

Quantum memory 148 may include a quantum read-only memory (QROM), quantum random-access memory (QRAM), or other similar quantum memory. The quantum memory 148 may store any of the information described in FIGS. 1 and 2 along with any other data, such as access control rules 150, instructions, logic, rules, or code operable to implement the function(s) described herein. The quantum memory 148 is operable to store software instructions, and/or any other data and instructions. The software instructions may include any suitable set of software instructions, logic, rules, or code operable to be executed by the quantum processor 129. In one embodiment, the quantum memory 148 may include a non-transitory computer-readable medium.

### Dynamic Network Sandbox

In particular embodiments, as generally discussed above, the quantum computing system 109 may utilize the one or more classical machine-learning (CML) models 152, the one or more quantum machine-learning (QML) models 154, or some combination thereof to generate and instantiate a dynamic network sandbox 107 utilized to protect the classical computing system 108, the quantum computing system 109, and network 102 (e.g., quantum mesh network) against the advanced tactics, techniques, and procedures (TTPs) of cyberattackers, eavesdroppers, snoopers, or other similar adversarial users 104.

Specifically, in accordance with the presently disclosed embodiments, the quantum computing system 109 may generate the dynamic network sandbox 107 utilizing one or more of the classical machine-learning (CML) models 152 and/or one or more quantum machine-learning (QML) models 154 to accurately emulate the network 102 and personalize the dynamic network sandbox 107 to the user 104 (e.g., potential adversarial user 104), such that as the user 104 (e.g., potential adversarial user 104) executes adversarial user interactions 126 and/or traverses the dynamic network sandbox 107, the dynamic network sandbox 107 tracks the adversarial user interactions 126 and generatively presents sequences of different decoy data 128 that are specifically responsive to the tracked adversarial user interactions 126.

For example, in particular embodiments, the quantum processor 129 may receive from the computing device 106 user interactions 124 performed by the user 104 (e.g., potential adversarial user 104) utilizing an instance of the software application 151 executing on the computing device 106. The quantum processor 129 may then execute one or more of the classical machine-learning (CML) models 152 and/or one or more of the quantum machine-learning (QML) models 154 as discussed above to analyze the user interactions 124 and determine whether the user interactions 124 correspond to adversarial user interactions 126.

For example, in one embodiment, one or more of the classical machine-learning (CML) models 152 and/or one or more of the quantum machine-learning (QML) models 154 may be trained on a data set of historical adversarial user interactions 126 to track user interactions 124 across the network 102 (e.g., quantum mesh network) and identify any potentially suspicious user interactions 124, such as suspicious user activities, suspicious user behaviors, suspicious user data inputs, and so forth.

In one example, the one or more of the classical machine-learning (CML) models 152 and/or the one or more of the quantum machine-learning (QML) models 154 may be trained to identify user interactions 126 as suspicious if the user interactions 126 include the user 104 (e.g., potential adversarial user 104) idling on the network 102 (e.g., quantum mesh network), launching and closing a large number of applications on the network 102 (e.g., quantum mesh network), taking an unusual amount of time (e.g., more than 10 minutes, more than 15 minutes, more than 20 minutes, more than 30 minutes) to navigate on the network 102 (e.g., quantum mesh network) to a specific application or activity, executing a program or code that uses only a small portion of a larger allocation of available computing or memory resources (e.g., executing a program or code that utilizes only a few megabytes (MBs) of a total allocation of a few gigabytes (GBs) or terabytes (TBs)), or other user interactions 126 that may be indicative of a malicious intent of the user 104 (e.g., potential adversarial user 104).

In one embodiment, the set of historical adversarial user interactions 126 utilized to train the one or more of the classical machine-learning (CML) models 152 and/or the one or more of the quantum machine-learning (QML) models 154 may include a publicly-available or proprietary data set of raw cyberthreat data 218, such as historical cyberthreats, cyberthreat intelligence (CTI) data feeds (e.g., indicators of compromise (IoCs) of common cyberattacks, cybersecurity news, detailed analyses of malwares, web-based postings or messages surrounding emerging cyberthreats), a set of penetration testing results (e.g., “pen tests”), and so forth. In another embodiment, the set of historical adversarial user interactions 126 utilized to train the one or more of the classical machine-learning (CML) models 152 and/or the one or more of the quantum machine-learning (QML) models 154 may include a publicly-available or proprietary data set of artifacts recorded during an incident response cycle or known attack vectors learned from the current threat landscape.

In particular embodiments, in response to a determination that the user interactions 124 correspond to adversarial user interactions 126, the quantum processor 129 may then execute one or more other classical machine-learning (CML) models 152 and/or one or more other quantum machine-learning (QML) models 154 trained on the data set of historical adversarial user interactions 126 to generate the dynamic network sandbox 107 suitable for restricting the execution of the adversarial user interactions 126 to only the dynamic network sandbox 107. In some embodiments, the dynamic network sandbox 107 may include an emulation of the network 102 (e.g., quantum mesh network).

For example, the dynamic network sandbox 107 as an emulation (e.g., a decoy emulation of the “real” quantum mesh network 102) may include any isolated virtual computing environment in which software applications (e.g., software applications 151), virtual computing node devices (e.g., “N1,” “N2,” “N3,” “N4,” “N5,” “N6,” “N7,” and “N8”) corresponding to virtual representations of quantum processor 129 and/or classical processor 130, and network communication links (e.g., dashed lines representing wireless RF communication links and solid lines representing optical fiber or free-space optical communication links) may be each emulated or simulated for prompting and eliciting the user 104 (e.g., potential adversarial user 104) to continue interacting within the dynamic network sandbox 107 and with the sequences of different decoy data 128 all while being isolated and restricted to the dynamic network sandbox 107.

In other embodiments, the dynamic network sandbox 107 may include a virtual quantum mesh network of virtual machines (VMs) representative of the computing node devices (e.g., “N1,” “N2,” “N3,” “N4,” “N5,” “N6,” “N7,” and “N8”). For example, the dynamic network sandbox 107 as a virtual quantum mesh network may include individual VMs utilized to execute multiple instances of an operating system of the quantum processor 129 and/or the classical processor 130, such that a “real” (e.g., legitimate) operating system executing on the quantum processor 129 and/or the classical processor 130 is completely isolated from the virtualized operating system executing on the individual VMs. In such an embodiment, instead of a complete emulation of the network 102 (e.g., quantum mesh network) including the software applications, computing node devices, and network communication links, the dynamic network sandbox 107 may include individual VMs that execute a virtualized operating system in isolation.

In particular embodiments, upon the dynamic network sandbox 107 being initially generated and instantiated, the quantum processor 129 may further execute the one or more other classical machine-learning (CML) models 152 and/or the one or more other quantum machine-learning (QML) models 154 to cause the dynamic network sandbox 107 to generatively present sequences of different decoy data 128 to the user 104 (e.g., potential adversarial user 104) that is responsive to the execution of the adversarial user interactions 126. For example, in one embodiment, the different decoy data 128 may include the mesh network of virtual computing node devices (e.g., “N1,” “N2,” “N3,” “N4,” “N5,” “N6,” “N7,” and “N8”), such that as the user 104 (e.g., potential adversarial user 104) executes adversarial user interactions 126 and/or traverses between different virtual computing node devices (e.g., “N1,” “N2,” “N3,” “N4,” “N5,” “N6,” “N7,” and “N8”), the user 104 (e.g., potential adversarial user 104) would have a sense that the dynamic network sandbox 107 is “moving” or is dynamic and responsive in a manner in which the network 102 (e.g., quantum mesh network) would to respond to user interactions.

In other embodiments, the different decoy data 128 may include, for example, decoy virtual computing node devices (e.g., “N1,” “N2,” “N3,” “N4,” “N5,” “N6,” “N7,” and “N8”), decoy virtual databases, decoy applications, decoy services, decoy instances of operating systems, decoy user-performable tasks, decoy business data, decoy user data, or other decoy data that may be generatively presented to the user 104 (e.g., potential adversarial user 104) in real-time or near real-time so as to prompt and elicit the user 104 (e.g., potential adversarial user 104) to continue interacting within the dynamic network sandbox 107 and with the sequences of different decoy data 128 all while being isolated and restricted to the dynamic network sandbox 107.

In one example, the dynamic network sandbox 107 may prompt the user 104 (e.g., potential adversarial user 104) to execute one or more decoy user-performable tasks (e.g., executing on the virtual computing node devices (e.g., “N1,” “N2,” “N3,” “N4,” “N5,” “N6,” “N7,” and “N8”) to learn and log a digital identity (e.g., a user behavior unique to the user 104, a user intent of the user 104, user activities unique to the user 104, a user interaction pattern unique to the user 104, an internet protocol (IP) address of the computing device 106, an avatar unique to the user 104, and so forth) of the user 104 (e.g., potential adversarial user 104). For example, in one embodiment, the dynamic network sandbox 107 may prompt the user 104 (e.g., potential adversarial user 104) to execute decoy user-performable tasks, such as performing a drawing signature of a name or username, typing a block of text, responding to a predetermined set of questions and answers, coding an example program, receiving and opening a predetermined attachment, selecting one or more elements or attributes within a webpage that is otherwise hidden to unknown users, and so forth.

Continuing this example, the dynamic network sandbox 107 may also include a set of access control rules 150, such as a set of attribute-based access control (ABAC) policies, a set of access control lists (ACLs), or a set of rule-based access control (RBAC) policies, that may be associated with the decoy user-performable tasks and utilized to manage security policies with respect to the decoy user-performable tasks while the user 104 (e.g., potential adversarial user 104) is isolated and restricted to the dynamic network sandbox 107.

For example, to further prompt and elicit the user 104 (e.g., potential adversarial user 104) to continue interacting within the dynamic network sandbox 107 and with the sequences of different decoy data 128, the set of access control rules (e.g., ABAC policies, ACLs, RBAC policies) may associate restrictive access permissions (e.g., a stronger or more restrictive security policy) for the user 104 (e.g., potential adversarial user 104) when the user 104 (e.g., potential adversarial user 104) performs sensitive user-performable tasks. Sensitive user-performable tasks may include those user-performable tasks in which the user 104 (e.g., potential adversarial user 104) to execute unknown software applications (e.g., unknown software applications 151) or attempts to transfer data out from trusted a database or memory, such database 118 or quantum memory 148.

In particular embodiments, the set of access control rules (e.g., ABAC policies, ACLs, RBAC policies) may associate permissive access permissions (e.g., a weaker or more permissive security policy) for the user 104 (e.g., potential adversarial user 104) when the user 104 (e.g., potential adversarial user 104) performs non-sensitive user-performable tasks. Non-sensitive user-performable tasks may include those user-performable tasks in which the user 104 (e.g., potential adversarial user 104) is, for example, navigating the decoy virtual computing node devices (e.g., “N1,” “N2,” “N3,” “N4,” “N5,” “N6,” “N7,” and “N8”), launching and closing a number of applications, opening pre-scanned attachments (e.g., pre-scanned for malware), and so forth.

In particular embodiments, upon the user 104 (e.g., potential adversarial user 104) to completing the adversarial user interactions 126 within the dynamic network sandbox 107 and with the different decoy data 128, the quantum processor 129 may then store a log of the different decoy data 128, the adversarial user interactions 126, and the digital identity of the user 104 (e.g., potential adversarial user 104) to the quantum memory 148 and/or the database 118. In one embodiment, the quantum processor 129 may then determine to reject (e.g., block) any future user interactions 124 associated with the user 104 (e.g., potential adversarial user 104) and/or any future user interactions 124 from a computing device 106 associated with the user 104 (e.g., potential adversarial user 104).

In particular embodiments, rejecting (e.g., blocking) any future user interactions 124 associated with the user 104 (e.g., potential adversarial user 104) and/or any future user interactions 124 from a computing device 106 associated with the user 104 may include a permanent quarantining of the user 104 (e.g., potential adversarial user 104) from the network 102 (e.g., quantum mesh network). For example, in one embodiment, the user 104 (e.g., potential adversarial user 104) may be quarantined from the network 102 (e.g., quantum mesh network) by implementing an IP address banning in which all user interactions 124 originating from the IP address associated with the user 104 (e.g., potential adversarial user 104) is blocked from the network 102 (e.g., quantum mesh network).

In another embodiment, upon the user 104 (e.g., potential adversarial user 104) to completing the adversarial user interactions 126 within the dynamic network sandbox 107 and with the different decoy data 128, the quantum processor 129 may score the adversarial user interactions 126 executed within the dynamic network sandbox 107 and with the different decoy data 128 as being only suspicious or being malicious. For example, the user 104 (e.g., potential adversarial user 104) may have executed an unknown software application within the dynamic network sandbox 107 initially detected as being suspicious of obfuscating malicious content.

However, upon analysis (e.g., utilizing one or more advanced malware detection applications) of the different decoy data 128, the adversarial user interactions 126, and the digital identity of the user 104 (e.g., potential adversarial user 104) or by one or more incident response technicians, the quantum processor 129 may identify that the unknown software application executed within the dynamic network sandbox 107 did not include any malicious content. The quantum processor 129 may thus score the adversarial user interactions 126 executed within the dynamic network sandbox 107 and with the different decoy data 128 as being only suspicious. On the other hand, were the unknown software application executed within the dynamic network sandbox 107 determined to include malicious content, the quantum processor 129 would score the adversarial user interactions 126 executed within the dynamic network sandbox 107 and with the different decoy data 128 as being malicious.

In such an example in the adversarial user interactions 126 executed within the dynamic network sandbox 107 and with the different decoy data 128 is scored as being only suspicious, the quantum processor 129 may determine to allow future user interactions 124 associated with the user 104 (e.g., potential adversarial user 104) and/or any future user interactions 124 from a computing device 106 associated with the user 104 (e.g., potential adversarial user 104).

### Generating Dynamic Network Sandboxes Utilizing Quantum Computing

FIG. 2 illustrates a flowchart of an example method 200 for generating dynamic network sandboxes utilizing quantum computing, in accordance with one or more embodiments of the present disclosure. The method 200 may be performed by the combined classical computing and quantum computing system 100 as described above with respect to FIG. 1. For example, in one embodiment, the method 200 may be performed by the classical computing system 108 alone. In another embodiment, the method 200 may be performed by the quantum computing system 109 alone. In yet another embodiment, the method 200 may be performed in conjunction by the classical computing system 108 and the quantum computing system 109.

The method 200 may begin at block 202 with the classical computing system 108 and/or the quantum computing system 109 receiving, from at least one instance of a software application (e.g., software application 151) executing on a computing node device (e.g., computing device 106) associated with a user 104, a request to initiate an execution of one or more user interactions 124. For example, in one embodiment, the user 104 may launch an instance of the software application 151 on the computing device 106 and request to initiate an execution of one or more user interactions 124 with one or more of the classical computing system 108 or the quantum computing system 109. The method 200 may then continue at block 204 with the classical computing system 108 and/or the quantum computing system 109 determining, based on the initiation of the execution of the one or more user interactions 124, that the execution of the one or more user interactions 124 includes an execution of one or more adversarial user interactions 126.

For example, in one embodiment, the one or more classical machine-learning (CML) models 152 and/or the one or more quantum machine-learning (QML) models 154 may be utilized to determine whether the execution of the one or more user interactions 124 corresponds to an execution of one or more adversarial user interactions 126. In particular embodiments, the method 200 may continue at decision 206 with the classical computing system 108 and/or the quantum computing system 109 confirming whether the execution of the one or more user interactions 124 corresponds to an execution of one or more adversarial user interactions 126. In particular embodiments, in response to confirming that the execution of the one or more user interactions 124 does not correspond to an execution of one or more adversarial user interactions 126 (e.g., at decision 206), the method 200 may return to block 204.

On the other hand, in response to confirming that the execution of the one or more user interactions 124 corresponds to an execution of one or more adversarial user interactions 126 (e.g., at decision 206), the method 200 may continue at block 208 with the classical computing system 108 and/or the quantum computing system 109 training an artificial-intelligence algorithm based on the mesh network of interconnected computing node devices (e.g., quantum mesh network including the computing device 106, the classical computing system 108, the quantum computing system 109) and a set of historical adversarial interactions to generate a dynamic network sandbox 107.

The method 200 may then continue block 210 with the classical computing system 108 and/or the quantum computing system 109 executing, based on the execution of the one or more adversarial user interactions 126, and, in response to the training of the artificial-intelligence algorithm, an artificial-intelligence model (e.g., one or more classical machine-learning (CML) models 152, one or more quantum machine-learning (QML) models 154, or some combination thereof) to generate the dynamic network sandbox 107 configured to restrict the execution of the one or more adversarial user interactions 126 to only the dynamic network sandbox 107 and to generatively present sequences of different decoy data 128 to the user 104 (e.g., adversarial user 104) in response to the execution of the one or more adversarial user interactions 126.

In particular embodiments, the method 200 may continue at decision 212 with the classical computing system 108 and/or the quantum computing system 109 confirming whether the execution of the one or more adversarial user interactions 126 has been completed while restricted to the dynamic network sandbox 107. In particular embodiments, in response to confirming that the execution of the one or more adversarial user interactions 126 has not been completed while restricted to the dynamic network sandbox 107 (e.g., at decision 212), the method 200 may return to block 210.

On the other hand, in response to confirming that the execution of the one or more adversarial user interactions 126 has been completed while restricted to the dynamic network sandbox 107 (e.g., at decision 212), the method 200 may then continue at block 214 with the classical computing system 108 and/or the quantum computing system 109 uniquely identifying the user 104 (e.g., adversarial user 104) based on the generatively presented sequences of different decoy data 128 and the execution of the one or more adversarial user interactions 126. The method 200 may then conclude block 216 with the classical computing system 108 and/or the quantum computing system 109 restricting further requests to initiate executions of the one or more user interactions 124 from the uniquely identified user 104 (e.g., adversarial user 104).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a plurality of instances of a software application executable on a plurality of computing node devices and a set of historical adversarial interactions, wherein the plurality of computing node devices comprises a quantum mesh network of interconnected computing node devices; and
a quantum processor operably coupled to the memory and configured to:
receive, from at least one instance of the software application executing on a computing node device associated with a user, a request to initiate an execution of one or more user interactions;
determine, based at least in part on the initiation of the execution of the one or more user interactions, that the execution of the one or more user interactions comprises an execution of one or more adversarial user interactions, and, in response:
execute, based at least in part on the execution of the one or more adversarial user interactions, an artificial-intelligence model to generate a dynamic network sandbox comprising an emulation of the quantum mesh network of interconnected computing node devices configured to 1) restrict the execution of the one or more adversarial user interactions to only the dynamic network sandbox and to 2) generatively present sequences of different decoy data to the user in response to the execution of the one or more adversarial user interactions;
in response to determining at least a partial completion of the execution of the one or more adversarial user interactions while restricted to the dynamic network sandbox, uniquely identify the user based at least in part on the generatively presented sequences of different decoy data and the execution of the one or more adversarial user interactions; and
reject further requests from the uniquely identified user to initiate executions of the one or more user interactions.

2. The system of claim 1, wherein the quantum processor is further configured to execute the artificial-intelligence model to generate the dynamic network sandbox by generating a decoy quantum mesh network of interconnected computing node devices, and wherein the decoy quantum mesh network of interconnected computing node devices comprises one or more of the emulation of the quantum mesh network of interconnected computing node devices or a virtual quantum mesh network of virtual machines (VMs) representative of the computing node devices.

3. The system of claim 1, wherein the generatively presented sequences of different decoy data comprises a plurality of user-performable tasks configured to elicit the user to complete the execution of the one or more adversarial user interactions while restricted to the dynamic network sandbox.

4. The system of claim 3, wherein the quantum processor is further configured to associate with the plurality of user-performable tasks a set of access control rules, and wherein the set of access control rules comprises restrictive access permissions for the user when the user performs sensitive user-performable tasks and permissive access permissions for the user when the user performs non-sensitive user-performable tasks.

5. The system of claim 1, wherein the quantum processor is further configured to:
prompt the user to complete the execution of the one or more adversarial user interactions with the generatively presented sequences of different decoy data while restricted to the dynamic network sandbox, wherein the generatively presented sequences of different decoy data comprises a user-performable task;
score the execution of the one or more adversarial user interactions as being one of a suspicious user interaction or a malicious user interaction; and
determining whether to quarantine the user based at least in part on the score of the execution of the one or more adversarial user interactions.

6. The system of claim 1, wherein the quantum processor is further configured to store a log of the generatively presented sequences of different decoy data, the execution of the one or more adversarial user interactions, and a digital identity of the uniquely identified user.

7. The system of claim 1, wherein the quantum processor is further configured to:
train an artificial-intelligence algorithm based at least in part on the quantum mesh network of interconnected computing node devices and the set of historical adversarial interactions to generate the dynamic network sandbox; and
execute, based at least in part on the execution of the one or more adversarial user interactions, and in response to the training of the artificial-intelligence algorithm, the artificial-intelligence model to generate the dynamic network sandbox, wherein the artificial-intelligence model comprises one or more classical machine-learning (CML) models, one or more quantum machine-learning (QML) models, or a combination thereof.

8. A method, comprising:
receiving, from at least one instance of a software application executing on a computing node device associated with a user, a request to initiate an execution of a plurality of user interactions, wherein the computing node device comprises one of a plurality of computing node devices comprising a quantum mesh network;
determining, based at least in part on the initiation of the execution of the plurality of user interactions, that the execution of the plurality of user interactions comprises an execution of one or more adversarial user interactions, and, in response:
executing, based at least in part on the execution of the one or more adversarial user interactions, an artificial-intelligence model to generate a dynamic network sandbox comprising an emulation of the quantum mesh network of interconnected computing node devices configured to 1) restrict the execution of the one or more adversarial user interactions to only the dynamic network sandbox and to 2) generatively present sequences of different decoy data to the user in response to the execution of the one or more adversarial user interactions;
in response to determining at least a partial completion of the execution of the one or more adversarial user interactions while restricted to the dynamic network sandbox, uniquely identifying the user based at least in part on the generatively presented sequences of different decoy data and the execution of the one or more adversarial user interactions; and
rejecting further requests from the uniquely identified user to initiate executions of the one or more user interactions.

9. The method of claim 8, further comprising executing the artificial-intelligence model to generate the dynamic network sandbox by generating a decoy quantum mesh network of interconnected computing node devices, wherein the decoy quantum mesh network of interconnected computing node devices comprises one or more of the emulation of the quantum mesh network of interconnected computing node devices or a virtual quantum mesh network of virtual machines (VMs) representative of the computing node devices.

10. The method of claim 8, wherein the generatively presented sequences of different decoy data comprises a plurality of user-performable tasks configured to elicit the user to complete the execution of the one or more adversarial user interactions while restricted to the dynamic network sandbox.

11. The method of claim 10, further comprising associating with the plurality of user-performable tasks a set of access control rules, and wherein the set of access control rules comprises restrictive access permissions for the user when the user performs sensitive user-performable tasks and permissive access permissions for the user when the user performs non-sensitive user-performable tasks.

12. The method of claim 8, the method further comprising:
prompting the user to complete the execution of the one or more adversarial user interactions with the generatively presented sequences of different decoy data while restricted to the dynamic network sandbox, wherein the generatively presented sequences of different decoy data comprises a user-performable task;
scoring the execution of the one or more adversarial user interactions as being one of a suspicious user interaction or a malicious user interaction; and
determining whether to quarantine the user based at least in part on the score of the execution of the one or more adversarial user interactions.

13. The method of claim 8, further comprising storing a log of the generatively presented sequences of different decoy data, the execution of the one or more adversarial user interactions, and a digital identity of the uniquely identified user.

14. The method of claim 8, further comprising:
training an artificial-intelligence algorithm based at least in part on the quantum mesh network of interconnected computing node devices and a set of historical adversarial interactions to generate the dynamic network sandbox; and
executing, based at least in part on the execution of the one or more adversarial user interactions, and in response to the training of the artificial-intelligence algorithm, the artificial-intelligence model to generate the dynamic network sandbox, wherein the artificial-intelligence model comprises one or more classical machine-learning (CML) models, one or more quantum machine-learning (QML) models, or a combination thereof.

15. A non-transitory computer-readable medium storing instructions that, when executed by a quantum processor, cause the quantum processor to:
receive, from at least one instance of a software application executing on a computing node device associated with a user, a request to initiate an execution of a plurality of user interactions, wherein the computing node device comprises one of a plurality of computing node devices comprising a quantum mesh network;
determine, based at least in part on the initiation of the execution of the plurality of user interactions, that the execution of the plurality of user interactions comprises an execution of one or more adversarial user interactions, and, in response:
execute, based at least in part on the execution of the one or more adversarial user interactions, an artificial-intelligence model to generate a dynamic network sandbox comprising an emulation of the quantum mesh network of interconnected computing node devices configured to 1) restrict the execution of the one or more adversarial user interactions to only the dynamic network sandbox and to 2) generatively present sequences of different decoy data to the user in response to the execution of the one or more adversarial user interactions;
in response to determining at least a partial completion of the execution of the one or more adversarial user interactions while restricted to the dynamic network sandbox, uniquely identify the user based at least in part on the generatively presented sequences of different decoy data and the execution of the one or more adversarial user interactions; and
reject further requests from the uniquely identified user to initiate executions of the one or more user interactions.

16. The non-transitory computer-readable medium of claim 15, wherein the instructions further cause the quantum processor to execute the artificial-intelligence model to generate the dynamic network sandbox by generating a decoy quantum mesh network of interconnected computing node devices, and wherein the decoy quantum mesh network of interconnected computing node devices comprises one or more of the emulation of the quantum mesh network of interconnected computing node devices or a virtual quantum mesh network of virtual machines (VMs) representative of the computing node devices.

17. The non-transitory computer-readable medium of claim 15, wherein the generatively presented sequences of different decoy data comprises a plurality of user-performable tasks configured to elicit the user to complete the execution of the one or more adversarial user interactions while restricted to the dynamic network sandbox.

18. The non-transitory computer-readable medium of claim 17, wherein the instructions further cause the quantum processor to associate with the plurality of user-performable tasks a set of access control rules, and wherein the set of access control rules comprises restrictive access permissions for the user when the user performs sensitive user-performable tasks and permissive access permissions for the user when the user performs non-sensitive user-performable tasks.

19. The non-transitory computer-readable medium of claim 15, wherein the instructions further cause the quantum processor to:
prompt the user to complete the execution of the one or more adversarial user interactions with the generatively presented sequences of different decoy data while restricted to the dynamic network sandbox, wherein the generatively presented sequences of different decoy data comprises a user-performable task;
score the execution of the one or more adversarial user interactions as being one of a suspicious user interaction or a malicious user interaction; and
determining whether to quarantine the user based at least in part on the score of the execution of the one or more adversarial user interactions.

20. The non-transitory computer-readable medium of claim 15, wherein the instructions further cause the quantum processor to store a log of the generatively presented sequences of different decoy data, the execution of the one or more adversarial user interactions, and a digital identity of the uniquely identified user.
